(19) United States
(12) Patent Application Publication
(10) Pub. No.: US 2009/0206660 A1
(43) Pub. Date: Aug. 20, 2009

(54) DUAL POWER SUPPLY SYSTEM FOR A VEHICLE AND POWER SUPPLY METHOD

(75) Inventors: Mitsugu Makita, Aichi-ken (JP); Yoshinobu Kume, Aichi-ken (JP); Yoshitaka Ojima, Aichi-ken (JP); Shinya Araki, Aichi-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi, Aichi-ken (JP)

(21) Appl. No.: 12/301,161

(22) PCT Filed: Apr. 19, 2007
(86) PCT No.: PCT/IB07/01028

§ 371 Date: Nov. 17, 2008

(30) Foreign Application Priority Data
May 16, 2006 (JP) 2006-136316

(51) Int. Cl. H02J 7/14

(52) U.S. Cl. 307/9.1

(57) ABSTRACT

A dual power supply system for a vehicle includes a generator that generates an electric power by using a rotation output of an engine, a DC/DC converter connected to the generator, and a battery, connected to the generator, that supplies an electric power.

### BACKGROUND OF THE INVENTION

1. Field of the Invention

The present invention relates to a dual power supply system for a vehicle and a power supply method, in which one of power supplies is configured by a generator.

2. Background of the Invention

Conventionally, a driving apparatus having a dual power supply system has been published for a hybrid vehicle. This dual power supply system includes a motor/generator connected to an engine for exchanging torque with the engine; a high-voltage electric power storage device connected to the motor/generator for exchanging power with the motor-generator; a low-voltage electric power storage device for supplying power to a low-voltage electric load; and a DC-DC converter that connects the two storage devices so that they can exchange power in both directions. Here, the driving apparatus includes a control device configured to transmit power, from the low-voltage power storage device to the high-voltage power storage device, by driving the DC-DC converter when initiating the engine with the motor/generator (see, e.g., Japanese Patent Application Publication No. 2002-176704).

In such a conventional dual power supply system, as in the related art described above, the power storage devices (batteries) are arranged on the left and right side of the DC-DC converter as power supplies. Such a configuration is very reliable because respective batteries ensure the operation of loads when the DC-DC converter fails. However, this results in an expensive system. Further, because the dual power supply system occupies an excessively large accommodating space for the batteries compared to a single battery system, it is impractical to apply the dual power supply system to small vehicles having only small accommodating spaces.

### SUMMARY OF THE INVENTION

The invention provides a dual power supply system for a vehicle and a power supply method that can be configured at a relatively low cost without deteriorating the reliability thereof.

In a first aspect of the present invention, there is provided a dual power supply system for a vehicle including a generator, a DC/DC converter connected to the generator, and a battery connected to the generator via the DC/DC converter, and supplies an electric power. Herein, the generator generates an electric power by using a rotation output of an engine. In this manner, a dual power supply system can be configured by employing substantially one battery.

An electric power necessary for a normal operation of a load may be supplied by the battery and generated by the generator.

Further, loads required when pulling the vehicle over may be disposed on the input side and the output side of the DC/DC converter, and, when the DC/DC converter is not operating, the loads required when pulling the vehicle over may be supplied with the electric power of the battery and the electric power generated by the generator. With this configuration, because the power for loads necessary to pull over the vehicle can be ensured sufficiently, the high reliability of the dual power supply system can be maintained.

Further, while an engine is stopped, a load disposed on a generator side may be supplied with the electric power of the battery. With this configuration, an appropriate power supply can be secured for a load having a standby current.

Further, the DC/DC converter may be a step-down or step-up converter that operates only in a direction from the generator side to a battery side, and the load disposed on the generator side and connected to the battery via the DC/DC converter is also connected to the battery not via the DC/DC converter. With this configuration, even if a load that has a standby current is disposed on the generator side, a necessary power supply can be secured for the load with a simple configuration. Further, loads can be divided into two parts by disposing the loads dividedly on the generator side and the battery side depending on the power consumption characteristics of the respective loads.

Further, the battery may be connected to the load disposed on the generator side via an additional DC/DC converter. The additional DC/DC converter has a smaller capacity than the DC/DC converter and is used in supplying standby currents. With this configuration, even if a plurality of loads that have standby currents are disposed on the generator side, a necessary power supply can be secured for the plurality of loads efficiently. Further, loads can be splitted in two parts by being disposed either on the generator side or the battery side depending on the power consumption characteristics of the respective loads.

Further, the DC/DC converter may be a bi-directional step-up and step-down converter, and the DC/DC converter operates in a first direction from the generator side to the battery side while the engine is operating, and operates in a second direction from the battery side to the generator side when the engine is stopped. With this configuration, even if a load that has a standby current is disposed on the generator side, a necessary power supply can be secured for a plurality of loads efficiently. Further, loads can be splitted in two parts by being disposed either on the generator side or the battery side depending on the power consumption characteristics of the respective loads.

Further, while the engine is stopped, the DC/DC converter may supply the electric power of the battery to the load disposed on the generator side by an intermittent operation. With this configuration, a necessary power supply for the load that has a standby current is secured while suppressing unnecessary power consumption.

Further, the DC/DC converter may be switched from the intermittent operation to a continuous operation before the engine is started. With this configuration, the required electric power for the load on the generator side, which may be increased before the engine is started, can be supplied while suppressing unnecessary power consumption.

Further, if a pre-engine start stage is detected while the engine is stopped, the DC/DC converter is switched from the intermittent operation to a continuous operation. With this configuration, the required electric power for the load on the generator side, which may be increased before the engine is started, can be supplied efficiently.

Further, an operation direction of the DC/DC converter may be switched from the first direction to the second direction before the engine is stopped if a pre-engine stop stage is detected. With this configuration, the required electric power for the load on the generator side, which may be cut off abruptly when the engine is stopped, can be secured without an instantaneous interruption.

Further, if the electric power generated by the generator is greater than an electric power required for the load disposed on the generator side, the battery may be charged by using the electric power generated by the generator.

Further, if a charged state of the battery is equal to or higher than a threshold level, and the electric power generated by the generator is greater than the electric power required for the load disposed on the generator side, the amount of electric power generated by the generator may be suppressed. With this configuration, the power generation control for the generator can be optimized.

Further, a low-voltage load may be connected to a generator side of the DC/DC converter, and a high-voltage load may be connected to a battery side of the DC/DC converter. With this configuration, it is not necessary to allocate excessive performance specifications for the generator or the DC/DC converter. In addition, effects on other loads that may be caused by operation of a short-term high-voltage load can be reduced.

In accordance with the second aspect of the present invention, there is provided a power supply method for a vehicle, in which all electric powers consumed by the vehicle are supplied essentially by a battery and a generator connected to the battery via a DC/DC converter. The method generates an electric power by the generator by using a rotation output of an engine.

Further, the method may further supply the electric power of the battery to the load disposed on the generator side via the DC/DC converter, while the engine is stopped.

Further, the method may further supply the electric power of the battery to the load disposed on the generator side not via the DC/DC converter, while the engine is stopped.

Further, in the method, while the engine is stopped, the load disposed on the generator side may be supplied with the electric power of the battery via an additional converter.

Further, the DC/DC converter may be a bi-directional step-up and step-down converter. The method may further operates the DC/DC converter in a first direction from a generator side to a battery side while the engine is operating, and may operate the DC/DC converter in a second direction from the battery side to the generator side while the engine is stopped.

Further, in the method, while the engine is stopped, the DC/DC converter may supply the electric power of the battery to the load disposed on the generator side by an intermittent operation.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a system configuration diagram illustrating principal elements of a vehicle power supply system in accordance with a first embodiment of the present invention;

FIG. 2 is a control system of the vehicle power supply system in accordance with the first embodiment of the present invention;

FIG. 3 is a system configuration diagram illustrating principal elements of a vehicle power supply system in accordance with a second embodiment of the present invention;

FIG. 4 is a system configuration diagram illustrating principal elements of the vehicle power supply system in accordance with a modification of the second embodiment of the present invention;

FIG. 5 is a system configuration diagram illustrating principal elements of a vehicle power supply system in accordance with a third embodiment of the present invention;

FIG. 6 is a flowchart showing a first example of a controlling method for a DC/DC converter, which is executed by a control device when an engine is stopped;

FIG. 7 is a flowchart showing a second example of the controlling method for the DC/DC converter, which is executed by the control device when the engine is stopped;

FIG. 8 is a flowchart showing a third example of the controlling method for the DC/DC converter 80C, which is executed by the control device when the engine is stopped;

FIG. 9 is a system configuration diagram showing principal elements of a vehicle power supply system in accordance with a fourth embodiment of the present invention;

FIG. 10 is a flowchart showing an example of a controlling method for a vehicle power supply system, which is executed by a control device and an engine ECU when an engine of the vehicle is being stopped;

FIG. 11 is a system configuration diagram illustrating principal elements of a vehicle power supply system in accordance with a fifth embodiment of the present invention;

FIG. 12 is a flowchart illustrating an example of a controlling method for a vehicle power supply system, which is executed by a control device when an engine of the vehicle is being initiated;

FIG. 13 is a system configuration diagram illustrating principal elements of a vehicle power supply system in accordance with a sixth embodiment of the present invention;

FIG. 14 is a flowchart illustrating an example of a controlling method for a vehicle power supply system, which is executed by a control device with respect to battery charging; and

FIG. 15 is a flowchart illustrating another example of the controlling method for the vehicle power supply system, which is executed by the control device with respect to the battery charging.

### DETAILED DESCRIPTION OF THE PREFERRED EMBODIMENTS

Hereinafter, embodiments of the present invention will be described with reference to the accompanying drawings.

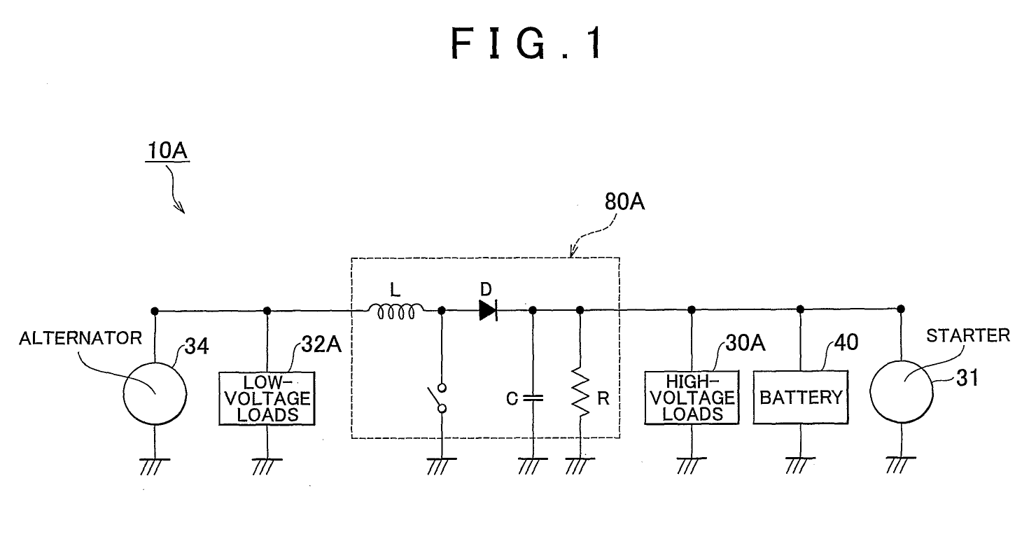

FIG. 1 is a system configuration diagram illustrating principal elements of a vehicle power supply system in accordance with a first embodiment of the present invention.

A vehicle power supply system 10A in accordance with the first embodiment includes a DC/DC converter 80A; a battery 40; and an alternator 34, where the battery 40 and the alternator 34 are connected to each other via the DC/DC converter 80A. A high-voltage load 30A, along with the battery 40, is connected to an output terminal of the DC/DC converter 80A in accordance with the first embodiment of the present invention. Further, a low-voltage load 32A, along with the alternator 34, is connected to an input terminal of the DC/DC converter 80A.

The battery 40 is a high-voltage power supply having a rated voltage of, for example, 42V. The battery 40 may be a lead battery or a lithium ion battery, or configured by a capacitive load such as an electric double layer capacitor.

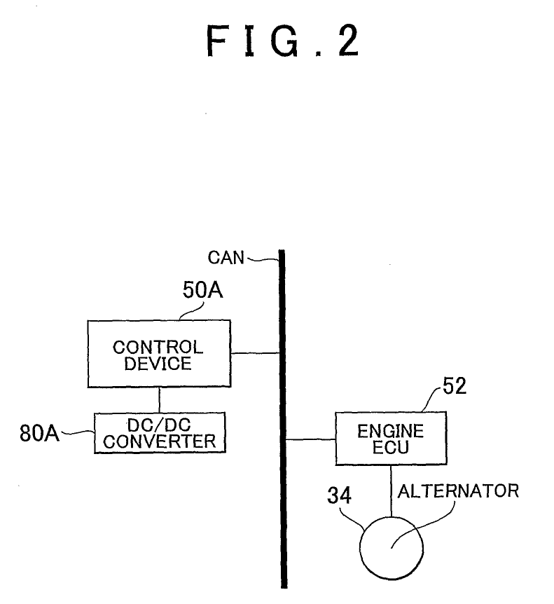

The DC/DC converter 80A is a step-up DC/DC converter, as shown in FIG. 1, which converts DC voltage from 14V to 42V in the present embodiment. The switching element for the DC/DC converter 80A is controlled by a control device 50A (see FIG. 2). Further, as long as the DC/DC converter 80A is configured to perform a step-up conversion from 14V to 42V, the phase number thereof and the type of switching element used therefor may be configured as desired, and may be of either an insulated or a non-insulated type.

The high-voltage load 30A is 42V load(s), and includes a starter 31 that operates at 42V to start the engine of the vehicle. In addition, the high-voltage load 30A may include other loads, such as a blower motor, a defogger, a brake actuator and a power steering unit (assist motor), through which high current flows temporarily during operation. Furthermore, the high-voltage load 30A may include still other loads, e.g. an anti-theft security system, capable of operating before starting or after stopping of the engine, besides the loads through which high current flows temporarily during an operation. Such loads require a circuit capable of converting voltage from 42V to 14V.

The low-voltage load 32A is 14V load(s) (load(s) other than the high-voltage load 30A), and may include, e.g., various kinds of lamps, meters or ECUs.

In the first embodiment, the alternator 34 generates an electric power of about 14V by engine rotation. The amount of power to be generated by the alternator 34 is controlled by an engine ECU 52 (see FIG. 2), which controls the engine, in accordance with the driving condition. For example, while the vehicle is under a normal driving condition or when the engine is idling, the target power amount to be generated by the alternator 34 is controlled to have a value that prevents discharging of the battery 40. Further, the target power amount to be generated by the alternator 34 during vehicle deceleration (during operation of a regenerative brake) is set to a value higher than the target value set for the normal driving condition or the engine idling. Moreover, the target power amount during vehicle acceleration is adjusted so that an accumulated current amount corresponds with a predetermined target value. In addition, during idle stop (i.e., when the engine is stopped), the target power amount by the alternator 34 is zero (i.e., power generation is not performed). Further, the present invention is not limited to a specific type of power generation control for the alternator 34, and can thus be applied to any control type of power generation.

FIG. 2 is a view illustrating the control system of the vehicle power supply system 10A in accordance with the first embodiment. The vehicle power supply system 10A includes a control device 50A that controls the DC/DC converter 80A. The control device 50A may be configured by a microcomputer or a control circuit such as an application-specific integrated circuit (ASIC). Also, the control device 50A may be integrally formed with the unit of the DC/DC converter 80A.

The engine ECU 52 is connected to the control device 50A via a suitable bus such as controller area network (CAN). The control device 50A controls the vehicle power supply system 10A in cooperation with the engine ECU 52, which controls the amount of power generated by the alternator 34. The control device 50A is informed of the operating status of the engine or the generating state of the alternator 34 via communications with the engine ECU 52. In the same manner, the engine ECU 52 can be informed of the operating, status (including failures, etc.) of the DC/DC converter 80A via communications with the control device 50A.

Hereinafter, the principal operations of the vehicle power supply system 10A in accordance with the first embodiment, performed under the controls of the control device 50A and the engine ECU 52, will be described.

Upon turning on an ignition switch, the starter 31 is initiated by the power from the battery 40 to apply rotational inertia to a crankshaft. That is, the engine starts cranking. Further, when the engine reaches a sufficient engine rotational speed through fuel injection and ignition control supported by the cranking inertia, the starter 31 stops. That is, the engine is successfully started (a successful start-up).

Thereafter, when the engine is operating, the low-voltage load 32A is driven by the power (generated power) generated by the alternator 34. Further, the voltage of the power generated by the alternator 34 is stepped up to about 42V by the operation of the DC/DC converter 80A, and this stepped-up voltage is supplied to the high-voltage load 30A. When, for example, the state of charge (SOC) of the battery 40 is decreased or large discharging current is detected at the battery 40 after the engine is started, the target power amount to be generated by the alternator 34 is set to a high value, and the battery 40 is charged by the alternator 34.

Thus, in the present embodiment, the power of the battery 40 is used only under the following conditions: when the engine has not yet been started; when the alternator 34 is not operating; and when a high power, which cannot be supplied by electric power generated by the alternator 34, is requested from the high-voltage load 30A. After the engine is started, the operations of the loads 30A and 32A are normally operated by the power generated by the alternator 34.

If any failures (including operation failures and abnormalities in the DC/DC converter 80A. The same applies hereinafter) occur during the engine operation, thereby disabling supply of the power generated by the alternator 34 to the high-voltage load 30A through the DC/DC converter 80A, a warning is immediately sent to the driver so that the driver can pull over the vehicle to the side of the road.

In such a case, the alternator 34 generates electric power continuously, so that the operation of the low-voltage load 32A necessary to pull over the vehicle is ensured by the voltage generated by the alternator 34. Furthermore, functions of the high-voltage load 30A necessary to pull over the vehicle are ensured by the power from the battery 40. Herein, the term “pull over the vehicle” is used to indicate driving over a relatively short distance to place a vehicle in a safe place such as the shoulder of a road. The “functions of the high-voltage load 30A necessary to pull over the vehicle” refer to the functions of the various ECUs configured to stop the operations of loads used for driver's convenience such as an air conditioner, and/or the function of giving a priority to the loads required for driving the vehicle (for example, the braking by the brake device or the steering by the steering device).

As described above, in accordance with the present embodiment, the dual power supply system, which is divided into a high-voltage system and a low-voltage system, is implemented by using one battery, thus realizing reductions in cost and required accommodating space. Further, even when the DC/DC converter 80A fails to operate, power for the low-voltage load 32A and the high-voltage load 30A necessary to pull over the vehicle is supplied from the alternator 34 and the battery 40. Accordingly, a highly reliable power supply system is realized.

Furthermore, while the engine is stopped, no power is generated by the alternator 34. Accordingly, the low-voltage load 32A disposed on the alternator side (i.e., connected to one terminal of the converter 80A to which the alternator 34 is connected) cannot be operated. However, in the present embodiment, loads capable of operating before the engine starts or after the engine is stopped are disposed on the battery side (i.e., connected to the other terminal of the converter 80A to which the battery 40 is connected) as a part of the high-voltage load 30A. Therefore, even when the engine is stopped, the operation of necessary loads is ensured by the power supplied from the battery 40.

Further, in the present embodiment, because the battery 40 having a high rated voltage corresponding to the high-voltage load 30A is disposed on the side of the high-voltage load 30A, the high instantaneous electric power, which may be required to operate the high-voltage load 30A, can be drawn from the battery 40 as described above. Therefore, it is not necessary to allocate excessive performance specifications to the alternator 34 or the DC/DC converter 80B. Furthermore, when the high-voltage load 30A is in operation, the low-voltage load 32A is prevented from operating in an unstable condition (under which, e.g., the lamp flickers). Further, the present embodiment does not exclude a configuration in which high-voltage load 30A without the starter 31 is disposed on the alternator side. A step-down DC/DC converter may replace the step-up DC/DC converter 80A; the voltage generated by the alternator may be set to a high voltage of 42V; and the high-voltage load 30A may be disposed on the alternator side. Moreover, a battery having a rated voltage of 14V may be provided, and low-voltage load 32A may be disposed on the battery side.

In accordance with the present embodiment, in order to achieve a more advanced fail-safe feature, a small-sized battery (e.g., a capacitor) as a back-up power supply may be allotted to some of the low-voltage load 32A (e.g., a brake ECU and/or an airbag ECU) that are concerned with safe driving of the vehicle, among the low-voltage load 32A existing on the alternator side. In this case, for example, even if the alternator 34 is disabled or insufficient to generate power in the event of a failure of the alternator 34, the small-sized battery can supply a minimum power necessary to pull over the vehicle to a specific low-voltage load 32A.

A second embodiment of the present invention differs from the first embodiment chiefly in that the second embodiment has a configuration in which the standby current of the low-voltage load is taken into account. Hereinafter, the elements identical to those of the above first embodiment will be respectively assigned the same reference numerals, and descriptions thereof will be omitted.

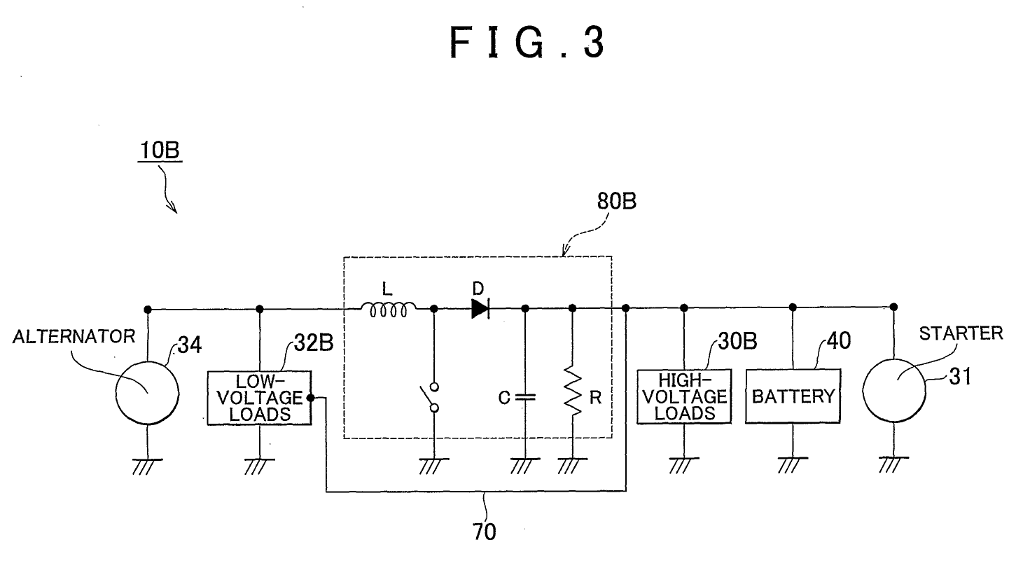

FIG. 3 is a system configuration diagram illustrating the principal elements of a vehicle power supply system in accordance with the second embodiment of the present invention.

A vehicle power supply system 10B in accordance with the second embodiment includes a DC/DC converter 80B; a battery 40; and an alternator 34, where the battery 40 and the alternator 34 are connected to each other via the DC/DC converter 80B. The DC/DC converter 80B is a step-up DC/DC converter, as shown in FIG. 3, which converts DC voltage from 14V to 42V in the present embodiment. A high-voltage load 30B, along with the battery 40, is connected to an output terminal of the DC/DC converter 80B in accordance with the present embodiment. Further, a low-voltage load 32B, along with the alternator 34, is connected to an input terminal of the DC/DC converter 80B.

The high-voltage load 30B is 42V load(s), and includes a starter 31 that starts the engine. In addition, the high-voltage load 30B further includes a short-term high power load that requires high electric power for a relatively short period of time, such as a blower motor, a defogger, a brake actuator, a power steering unit (assist motor) and so forth. The low-voltage load 32B is 14V load(s) (load(s) other than the high-voltage load 30B), and includes low-power load(s). The low-voltage load 32B may include, e.g., various lamps, meters or ECUs. However, unlike the low-voltage load 32A in the first embodiment, the low-voltage load 32B may have a standby current for maintaining a RAM or a low-power load capable of operating when the engine is stopped, such as an anti-theft security system.

In the second embodiment, the low-voltage load 32B is disposed on the alternator side, and is connected to the battery 40 via a standby current supply line 70 such that the low-voltage load 32B can be electrically coupled to the battery 40 without being connected via the DC/DC converter 80B. That is, the standby current supply line 70 is drawn from an output side (the battery side) of the DC/DC converter 80B, and is connected to the low-voltage load 32B.

Not all parts of the low-voltage load 32B need to be connected to the battery 40 through the standby current supply line 70. Only necessary loads are connected to the battery 40. That is, among the low-voltage load 32B, a load that operates for the purpose of, for example, timekeeping (clock operation) or the backup of RAM, and various standby current loads, such as an audio device, a car navigation device and various security systems, need to be connected to the battery 40. Further, among the parts of the low-voltage load 32B, a load that requires or prefers to add redundancy to the power supply so as to ensure the safety of a vehicle, along with the standby current loads, may be connected to the battery 40. Typically, such a load includes, for example, a brake ECU essential for braking of the vehicle, an emergency call system (a Mayday system) designed to communicate with an external facility (center) in emergency, and the like. Hereinafter, unless described otherwise, it is assumed that the standby current supply line 70 is connected to all the parts of the low-voltage load 32B.

The low-voltage load 32B contains a device capable of converting a voltage from 42V to 14V. This device may be a resistor voltage dividing circuit formed within a load circuit, or a step-down circuit formed of a small-sized DC/DC converter or a dropper type regulator. If a separate DC/DC converter is used to supply a standby current, the DC/DC converter is a step-down converter capable of converting a voltage from 42V to 14V, and can thus have a small-sized configuration (e.g., a configuration lacking heat-dissipation means or a heat-dissipation area), unlike the DC/DC converter that manages high electric power. It is, therefore, possible to place the small DC/DC converter within the low-voltage load 32B.

A feed power line from the battery 40 (i.e., the standby current supply line 70) and a feed line from the alternator 34 are switchably connected to the low-voltage load 32B. This type of connection may be realized by using a logic circuit (including a diode OR connection).

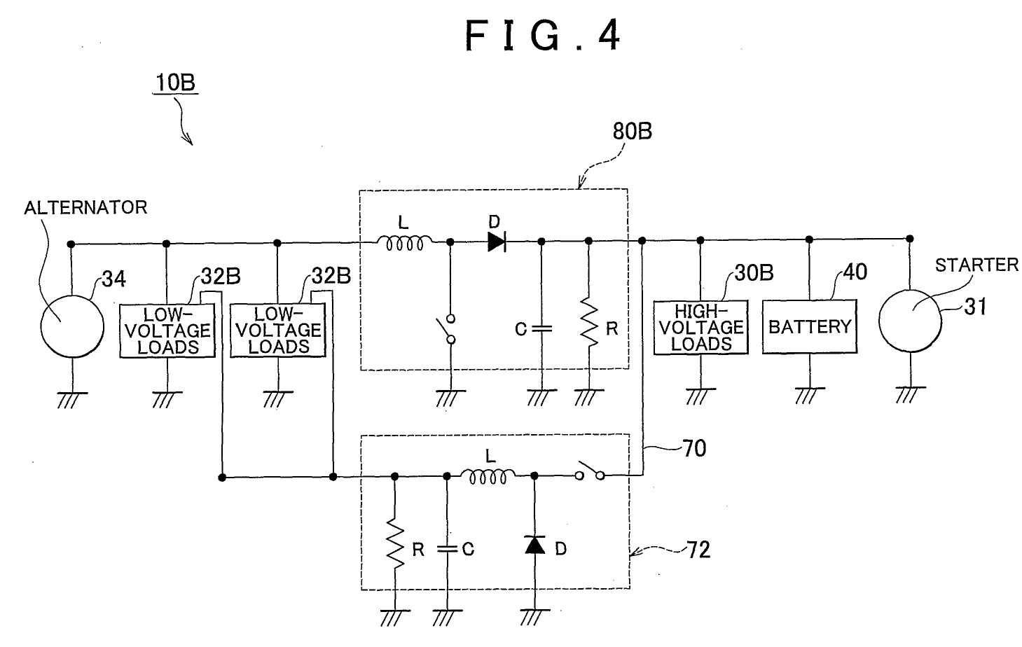

FIG. 4 is a system configuration diagram illustrating principal elements of a vehicle power supply system in accordance with a modification of the second embodiment of the present invention. The modification shown in FIG. 4 differs from the second embodiment shown in FIG. 3 in that a common step-down DC/DC converter 72 that converts a voltage from 42V to 14V is disposed in front of the low-voltage loads 32B. As described above, the DC/DC converter that mainly serves to supply a standby current can have a small-sized configuration (e.g., a chip configuration), and can be contained in each of the low-voltage loads 32B as in the second embodiment shown in FIG. 3. However, when standby currents are required by a plurality of low-voltage loads 32B as in the modification shown in FIG. 4, the common DC/DC converter 72 for the respective low-voltage loads 32B may be externally installed, so that a single device can perform the voltage conversion from 42V to 14V for the plurality of low-voltage loads 32B. Here, the power supply to the low-voltage loads 32B may be switched between the alternator 34 and the battery 40 by controlling the output voltage of the DC/DC converter 72 as in the second embodiment of FIG. 3.

Hereinafter, principal operations of the power supply system 10B for a vehicle in accordance with the present embodiment (including the modification thereof) will be described. If an ignition switch is turned on, the starter 31 is operated by the power from the battery 40 to start up the engine.

Thereafter, when the engine is started, the low-voltage load(s) 32B is driven by electric power (generated power) generated by the alternator 34. Then, the voltage from the alternator 34 is boosted to about 42V by the operation of the DC/DC converter 80B, and is supplied to the high-voltage load 30B. Further, the power generated by the alternator 34 is used to charge the battery 40 in the following case, for example: when the SOC of the battery 40 is lowered or when a high discharging current is detected from the battery 40.

If a failure of the DC/DC converter 80B occurs, and thus the alternator 34 cannot supply power to the high-voltage load 30B via the DC/DC converter 80B while the engine is running, the alternator 34 continuously generates power. Therefore, the operation of the low-voltage load(s) 32B necessary to pull over the vehicle is ensured by the voltage generated by the alternator 34. Further, the function of the high-voltage load 30B necessary to pull over the vehicle is ensured by the power from the battery 40.

Further, when a failure occurs in the alternator 34, and thus the power generation by the alternator 34 is impossible or insufficient while the engine is running, the operation of the low-voltage load(s) 32B necessary to pull over the vehicle is ensured by the power supplied from the battery 40 through the standby current supply line 70. Also, the function of the high-voltage load 30B necessary to pull over the vehicle is ensured by the power from the battery 40.

Further, when the engine stopped, the alternator 34 is unable to generate power. The supply of power to the low-voltage load(s) 32B is thus achieved by the battery 40 through the standby current supply line 70 in the same manner as the above case where a failure occurs in the alternator 34. Accordingly, although a load that can operate before the engine is started or after the engine is stopped is not disposed on the battery side as a part of the high-voltage load 30B, the operation of that loads can be ensured by using the power from the battery 40 when the engine is stopped. As a result, various loads can be appropriately disposed on the low-voltage side and the high-voltage side depending on the power consumption characteristics of the respective loads (e.g., depending on whether high electric power is consumed).

In accordance with the second embodiment, as in the first embodiment, the dual power supply system, which is divided into a high-voltage system and a low-voltage system, can be implemented by using one battery, thus realizing reductions in cost and required accommodating space. Further, even if the DC/DC converter 80B fails to operate, the power for the low-voltage load(s) 32B and the high-voltage load 30B necessary to pull over the vehicle can be supplied by the alternator 34 and the battery 40, respectively. A highly reliable power supply system is, thus, realized.

Furthermore, in accordance with the present second embodiment, even if the alternator 34 fails to operate, the power for the low-voltage load(s) 32B and the high-voltage load 30B necessary to pull over the vehicle can be supplied from the battery 40 through the standby current supply line 70. A highly reliable power supply system is, thus, realized.

Further, in the present embodiment, the battery 40 having a high rated voltage of 42V is disposed on the high-voltage load side. Therefore, as described above, high instantaneous power, which may be necessary to operate the high-voltage load 30B, can be obtained by drawing the power from the battery 40. Therefore, it is not necessary to allocate excessive performance specifications to the alternator 34 and the DC/DC converter 80B. Further, the present embodiment does not exclude a configuration in which the high-voltage load 30B without the starter 31 is disposed on the alternator side. In other words, a step-down DC/DC converter may be used instead of the step-up DC/DC converter 80B, the high-voltage load 30B may be disposed on the alternator side, and the low-voltage load(s) 32B may be disposed on the battery side.

Further, in the present embodiment, the battery 40 may be formed of a tapped battery to which a 14V tap attached. In this case, the standby current supply line 70 is drawn from a low voltage terminal (a 14V terminal) installed at the battery 40 to be directly connected to the low-voltage load(s) 32B. The low voltage terminal is formed between a high voltage terminal of the battery 40 (a terminal connected to the output terminal of the DC/DC converter 80B) and a ground. The low voltage terminal may be formed by attaching a tap to an appropriate cell part (a cell part corresponding to 14V) of a lamination cell included in the battery 40, for example. In this configuration, means for converting voltage from 42V to 14V (a resistance voltage dividing circuit, etc.) may not be needed within the low-voltage load(s) 32B. Furthermore, it is also not necessary to provide the DC/DC converter 72.

Further, in accordance with the present embodiment, to achieve a more advanced fail-safe feature, a small-sized battery as a back-up power supply may be allotted for some of the low-voltage load(s) 32B (for example, a brake ECU or an airbag ECU) that are concerned with safe driving of the vehicle, among the low-voltage load(s) 32B existing on the alternator side. In this case, for example, even if the standby current supply line 70 is cut or the voltage conversion means fails at the same time when the alternator 34 fails to operate, the small-sized battery can supply a minimum power necessary to pull over the vehicle to a specific low-voltage load(s) 32B.

A third embodiment of the present invention differs from the first embodiment mainly in that the DC/DC converter can be operated in a bi-directional manner. Hereinafter, the elements identical to those of the first embodiment will be respectively assigned the same reference numerals, and descriptions thereof will be omitted.

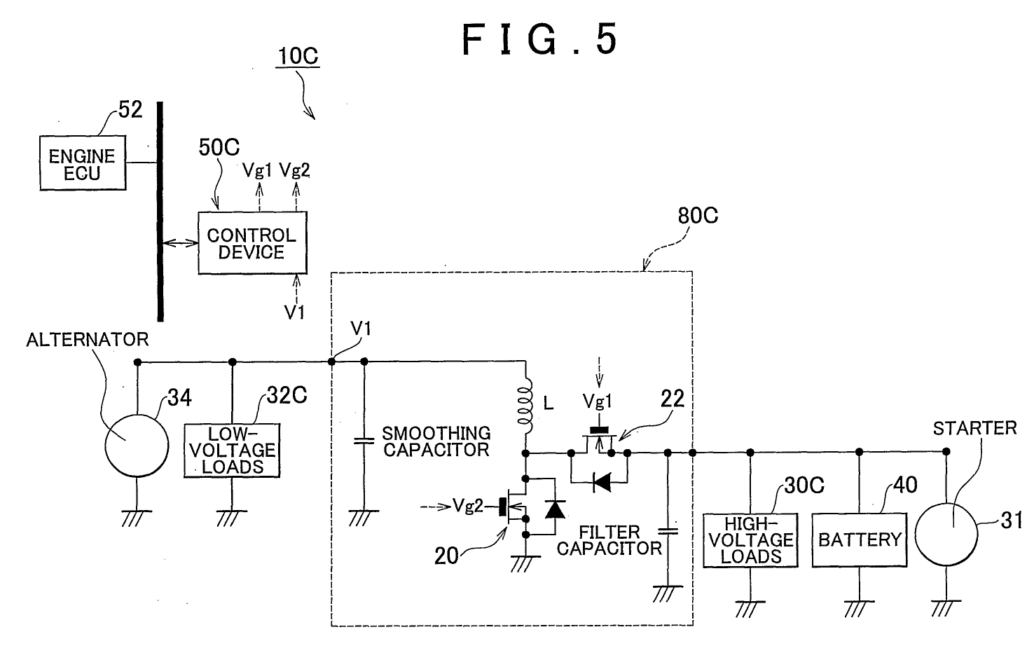

FIG. 5 is a system configuration diagram illustrating principal elements of a vehicle power supply system in accordance with the third embodiment of the present invention. In FIG. 5, a control system and a power supply system are illustrated as being divided. However, although a control device SOC and an engine ECU 52 are not depicted as loads of the vehicle power supply device, the control device 50C and the engine ECU 52 are actually included in, for example, a low-voltage load 32C.

The vehicle power supply system 10C in accordance with the third embodiment includes a DC/DC converter 80C, a battery 40, and an alternator 34, where the battery 40 and the alternator 34 are connected to each other via the DC/DC converter 80C. A high-voltage load 30C, along with the battery 40, is connected to a high-voltage side of the DC/DC converter 80C in accordance with the present embodiment. Further, a low-voltage load 32C, along with the alternator 34, is connected to a low-voltage side of the DC/DC converter 80C.

The battery 40 is a high-voltage power supply having a rated voltage of, for example, 42V. The battery 40 may be a lead battery or a lithium ion battery, or configured by a capacitive load such as an electric double layer capacitor.

The high-voltage load 30C is 42V load(s), and includes a starter 31 that starts the engine. In addition, the high-voltage load 30C may further include short-term high power loads which require high electric power for a relatively short period of time, such as a blower motor, a defogger, a brake actuator, a power steering unit (assist motor), and so on. The low-voltage load 32C is 14V load(s) (load(s) other than the high-voltage load 30C), and includes a low-power load. The low-voltage load 32C may include, e.g., various kinds of lamps, meters or ECUs. Further, unlike the low-voltage load 32A in the first embodiment, the low-voltage load 32C may include a low-power load capable of operating when the engine is stopped, such as an anti-theft security system.

The DC/DC converter 80C is a bi-directional DC/DC converter (a reversible chopper type step-up DC/DC converter) as shown in FIG. 5, which is capable of converting DC voltage from 14V to 42V and from 42V to 14V in the present embodiment.

In the example shown, in FIG. 5, the DC/DC converter 80C is a synchronous rectification and non-insulated DC/DC converter. A positive terminal of the battery 40 is connected to that of the alternator 34 through a coil element and a second switching element 22. The second switching element 22 is arranged such that the source thereof is on the battery side. A drain of a first switching element 20, whose source is grounded, is connected to the coil and the second switching element 22. Further, in the example shown in FIG. 5, the switching elements 20 and 22 are configured by metal oxide semiconductor field-effect transistors (MOSFETs). Furthermore, FIG. 5 shows a body diode formed in the MOSFET.

Further, as long as the DC/DC converter 80C is configured to perform a step-up conversion from 14V to 42V and a step-down conversion from 42V to 14V, the phase number thereof and the type of switching element used therefor may be configured as desired, and may be of either an insulated or a non-insulated type. For example, although the MOSFETs have been used as the switching elements in the example shown in FIG. 5, bipolar transistors, such as insulated gate bipolar transistors (IGBTs), may be used as the switching elements. Further, a third switching element that prevents an inrush current may be disposed between the coil and the smoothing capacitor.

The control device 50C, which controls voltage applied to gates of the switching elements 20 and 22, is connected to switching elements 20 and 22. The switching elements 20 and 22 are turned on and off by a driver (not shown) in response to driving signals Vg1 and Vg2 supplied from the control device 50C. The control device 50C monitors the voltage V1 (an output voltage V1 on the side of the alternator 34), which is a lower voltage of the DC/DC converter 80C.

The engine ECU 52 is connected to the control device 50C via an appropriate bus, such as CAN. The engine ECU 52 controls the amount of power generated by the alternator 34 as well as various operations of the engine as in the first embodiment described above. The control device 50C controls the operation of the vehicle power supply system 10C in cooperation with the engine ECU 52. The control device 50C is informed of the operating status of the engine or the generation status of the alternator 34 via communications with the engine ECU 52. In the same manner, the engine ECU 52 may also be informed of the operating status (including failures, etc.) of the DC/DC converter 80C via communications with the control device 50C.

Hereinafter, principal operations of the vehicle power supply system 10C in accordance with the third embodiment, performed under the control of the control device SOC and the engine ECU 52, will be described.

When the ignition switch is turned on, the starter 31 is operated by the battery 40 to start the engine.

When the engine is started, the low-voltage load 32C is operated by the power generated by the alternator 34. Furthermore, when the engine is started, the control device SOC operates (a step-up operation) the DC/DC converter 80C in the step-up direction (which is the direction from the alternator 34 to the battery 40). Therefore, the voltage generated by the alternator 34 is boosted from 14V to 42V via the DC/DC converter 80C, and is then supplied to the high-voltage load 30C. Further, the power generated by the alternator 34 is used to charge the battery 40 in the following case, for example: when the SOC of the battery 40 is lowered or when a high discharging current is detected from the battery 40.

If the DC/DC converter 80C fails during the engine operation, thereby disabling the supply of the power generated by the alternator 34 to the high-voltage load 30C through the DC/DC converter 80C, the function of the low-voltage load 32C necessary to pull over the vehicle is powered by the power generated by the alternator 34. Further, the function of the high-voltage load 30C necessary to pull over the vehicle is accomplished by the power from the battery 40.

Further, when the alternator 34 fails during the engine operation, thereby disabling power generation by the alternator 34 or making the generated power insufficient, the control device 50C switches the operation direction of the DC/DC converter 80C from the step-up direction to the step-down direction. In other words, the control device 50C operates (a step-down operation) the DC/DC converter 80C in the step-down direction (which is the direction from the battery 40 to the alternator 34). Therefore, the voltage of the battery 40 is stepped down from 42V to 14V by the DC/DC converter 80C, and is then supplied to the alternator 34. As described above, in the present embodiment, even if the alternator 34 fails to operate, the operation of the low-voltage load 32C necessary to pull over the vehicle can be ensured by the power supplied from the battery 40 through the DC/DC converter 80C. Further, the function of the high-voltage load 30C necessary to pull over the vehicle can be ensured by the power from the battery 40.

Further, when the engine is stopped, the power required for the low-voltage load 32C is supplied by the battery 40 via the DC/DC converter 80C in the same manner as when a failure occurs in the alternator 34. Accordingly, although a load that can operate before the engine is started or after the engine is stopped is not disposed on the battery side as a part of the high-voltage load 30C, the operation of that load when the engine is stopped can be ensured by the power from the battery 40 through the DC/DC converter 80C. Consequently, various loads can properly be disposed on the low-voltage side and the high-voltage side depending on the power consumption characteristics of the respective loads (i.e., depending on whether high electric power is consumed).

Thus, in accordance with the third embodiment, as in the first embodiment, the dual power supply system, which is divided into a high-voltage system and a low-voltage system, can be implemented by using one battery, thereby realizing reductions in cost and required accommodating space. Further, even if the DC/DC converter 80C fails to operate, the power for the low-voltage load 32C and the high-voltage load 30C necessary to pull over the vehicle can be supplied from the alternator 34 and the battery 40, respectively. A highly reliable power supply system, therefore, can be realized.

Furthermore, in accordance with the third embodiment, even if the alternator 34 fails to operate, the power for the low-voltage load 32C and the high-voltage load 30C necessary to pull over the vehicle can be supplied from the battery 40 through the DC/DC converter 80C. Accordingly, a highly reliable power supply system can be realized.

Further, in the present embodiment, the battery 40 having a high rated voltage of 42V is disposed on the high-voltage load side. Therefore, a high instantaneous power, which may be necessary when the high-voltage load 30C operates, can be obtained by drawing the power from the battery 40 as described above. Therefore, it is not necessary to allocate excessive performance specifications to the alternator 34 and the DC/DC converter 80C. Further, the present embodiment does not exclude a configuration in which the high-voltage load 30C without the starter 31 is disposed on the alternator side. In other words, the high-voltage load 30C may be disposed on the alternator side, and the low-voltage load 32C may be disposed on the battery side.

Further, in accordance with the present embodiment, in order to achieve a more advanced fail-safe feature, a small-sized battery may be allotted as a back-up power supply for some of the low-voltage load 32C (e.g., a brake ECU and/or an airbag ECU) that are concerned with safe driving of the vehicle, among the low-voltage load 32C existing on the alternator side. In this case, for example, even if both the DC/DC converter 80C and the alternator 34 fail simultaneously, the small-sized battery can still supply a minimum electric power necessary to pull over the vehicle to a specific low-voltage load 32C.

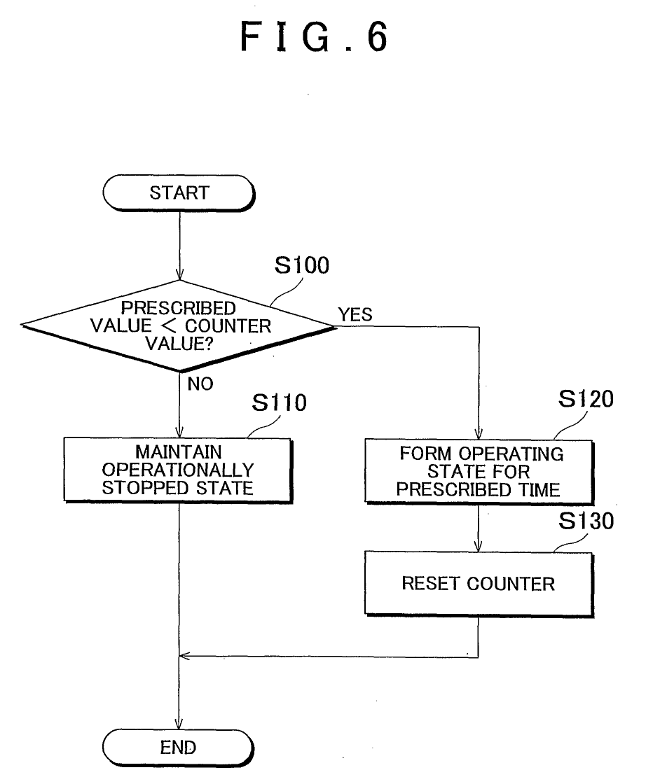

Hereinafter, an exemplary method of controlling the DC/DC converter 80C when the engine is stopped in accordance with the third embodiment will be described with reference to FIGS. 6 to 8.

FIG. 6 is a flowchart showing an example of a controlling method for a DC/DC converter 80C. The method is executed by a control device 50C when the engine is stopped. After the ignition switch of the engine is turned off, the process routine shown in FIG. 6 is performed every prescribed period.

At step S100, it is determined whether a counter value of a time counter is higher or lower than a prescribed value. The counter value of the time counter is set to zero when the first process begins. The prescribed value corresponds to an operation stoppage time in the intermittent operation of the DC/DC converter 80C. For example, if the amount of the standby current while the engine is stopped is a previously known nearly constant value, and the voltage V1 on the low-voltage side of the DC/DC converter 80C (i.e., a voltage of the low-voltage terminal of the converter 80C) is increased to a target value by the DC/DC converter 80C, the prescribed value (i.e., the operation stoppage time) may be a fixed value. Alternatively, if the amount of standby current while the engine is stopped can be changed or the voltage V1 at the time of operation stoppage of the DC/DC converter 80C can be changed, the prescribed value (the operation stoppage time) may vary based on the standby current and the voltage V1 detected when the operation of the DC/DC converter 80C is stopped.

If it is determined at step S100 that the counter value of the time counter is higher than the prescribed value, the control device 50C performs a step-down operation of the DC/DC converter 80C at step S120 for a prescribed amount of time. Accordingly, the voltage of the battery 40 is stepped down from 42V to 14V by the DC/DC converter 80C, and is then supplied to the alternator 34 side, so that the voltage V1 on the low-voltage load side is increased. Consequently, the operation according to the standby current of the low-voltage load 32C can be ensured for a while. Then, if the counter value becomes the prescribed value again, the step-down operation of the DC/DC converter 80C is performed again.

As described above, the control device 50C operates the DC/DC converter 80C for a prescribed time at step S120. Then, the control device 50C stops the operation of the DC/DC converter 80C, and resets the time counter to zero (step S130). Here, the prescribed value of step S100, which is reused for a next process of determination, may be set based on the standby current and the voltage V1 detected when the operation of the DC/DC converter 80C is stopped.

Meanwhile, if it is determined at step S100 that the counter value of the time counter is equal to or lower than the prescribed value, the control device 50C maintains the operation stoppage of the DC/DC converter 80C (step S110).

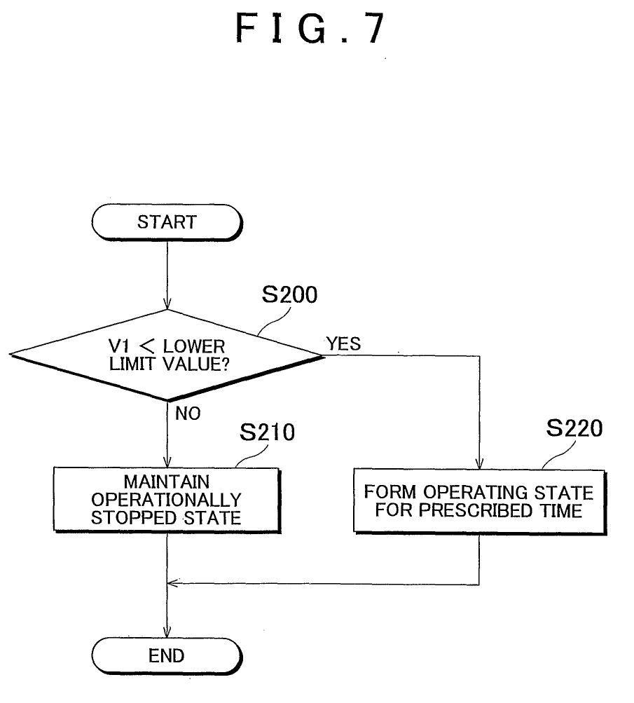

FIG. 7 is a flowchart showing another controlling method for the DC/DC converter 80C. The method is executed by the control device 50C while the engine is stopped. After the ignition switch of the engine is turned off, the process shown in FIG. 7 is performed every prescribed period.

At step S200, it is determined whether the voltage V1 is lower than a lower limit value based on a presently detected value of the voltage V1 on the low-voltage load side. The lower limit value may be obtained by adding a surplus value (that may be determined by, for example, considering a voltage margin, an operating time of the DC/DC converter 80C, and the like) to the lowest possible voltage necessary and sufficient for operating the low-voltage load 32C having the standby current.

If it is determined at step S200 that the voltage V1 is lower than the lower limit value, the control device 50C performs the step-down operation of the DC/DC converter 80C for a prescribed period of time at step 220. The prescribed period of time may vary (according to, for example, a mapping) depending on the voltage, the temperature, and the like, on the high-voltage load side. Accordingly, the voltage of the battery 40 is stepped down from 42V to 14V by the DC/DC converter 80C, and is then supplied to the alternator side, so that the voltage V1 on the low-voltage load side is increased. Consequently, the operation according to the standby current of the low-voltage load 32C is ensured for a while. Then, if the voltage V1 on the low-voltage load side becomes lower than the lower limit value due to the operation of the low-voltage load 32C, the step-down operation of the DC/DC converter 80C is performed again.

At step S220, the control device 50C operates the DC/DC converter 80C for a prescribed period. Thereafter, the control device 50C stops the operation of the DC/DC converter 80C again. Meanwhile, if it is determined at step S200 that the voltage V1 is equal to or higher than a lower limit value, the control device 50C maintains the operation stoppage of the DC/DC converter 80C (step S210).

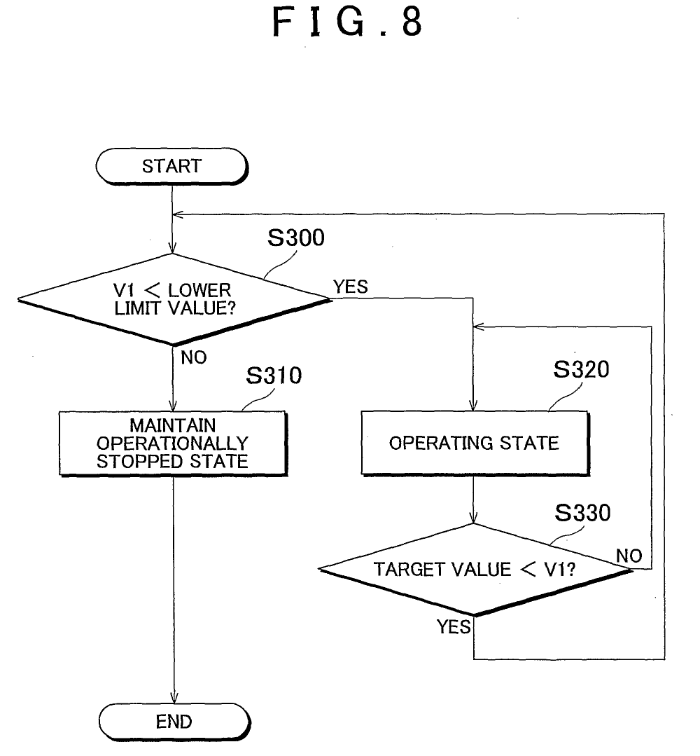

FIG. 8 is a flowchart showing another example of the controlling method for the DC/DC converter 80C. The method is executed by the control device 50C when the engine is stopped. After the ignition switch of the engine is turned off, the process shown in FIG. 8 is performed every prescribed period.

At step S300, it is determined whether the voltage V1 is lower than a lower limit value based on the presently detected value of the voltage V1 on the low-voltage load side. The lower limit value may be obtained by adding a surplus value (that is determined by, for example, considering a voltage margin, the operating time of the DC/DC converter 80C, and the like) to the lowest possible voltage necessary and sufficient for operating the low-voltage load 32C having the standby current.

If it is determined at step S300 that the voltage V1 is lower than the lower limit value, the control device 50C performs at step S320 the step-down operation of the DC/DC converter 80C until the voltage V1 on the low-voltage load side becomes higher than a target value (i.e., until YES at step S330). Accordingly, the voltage of the battery 40 is stepped down from 42V to 14V by the DC/DC converter 80C, and is then supplied to the alternator side, so that the voltage V1 on the low-voltage load side is increased to finally reach the target value. The target value may be the upper limit of the voltage V1 on the low-voltage load side. Consequently, the operation according to the standby current of the low-voltage load 32C can be ensured for a while. Then, if the voltage V1 on the low-voltage load side becomes lower than the lower limit value due to the operation of the low-voltage load 32C, the step-down operation of the DC/DC converter 80C is performed again.

The power required when the engine is stopped is very small compared to the actual ability of the DC/DC converter 80C. By taking this into consideration, in the present embodiment, the DC/DC converter 80C operates intermittently for supplying the standby current while the engine is stopped. The necessary supply of the standby current is, therefore, secured while prohibiting unnecessary power consumption.

A fourth embodiment of the present invention differs from the first embodiment chiefly in that a DC/DC converter is operated in a bi-directional manner, and is characterized mainly by a control method when the engine is stopped. Hereinafter, the elements identical to those of the first embodiment will be respectively assigned the same reference numerals, and descriptions thereof will be omitted.

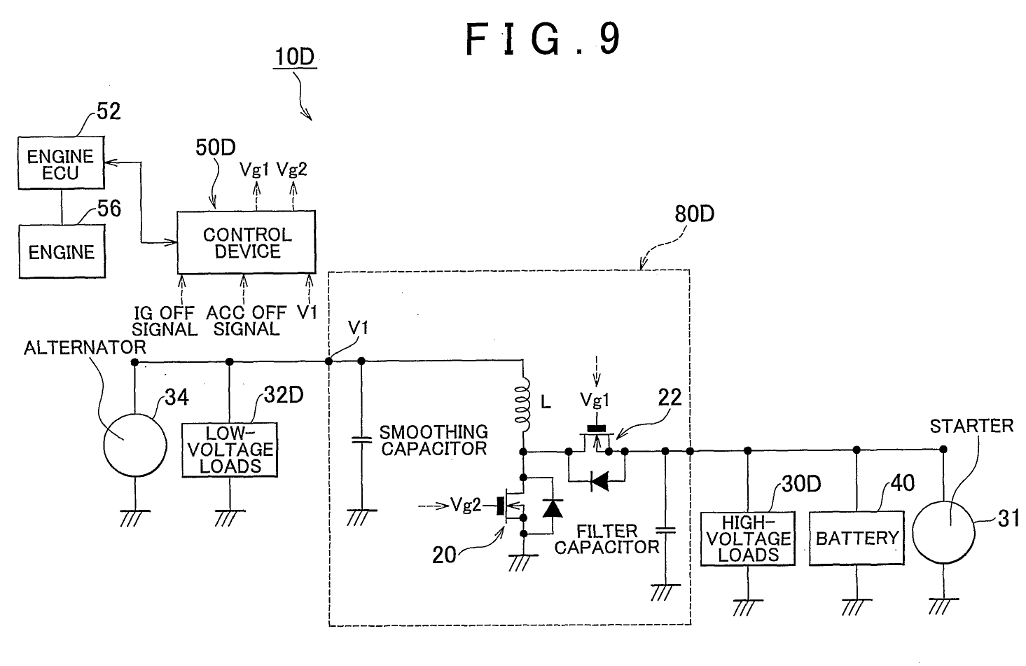

FIG. 9 is a system configuration diagram illustrating principal elements of a vehicle power supply system in accordance with the fourth embodiment of the present invention. In FIG. 9, a control system and a power supply system are illustrated as being divided. However, although a control device 50D, an engine ECU 52 and an engine 56 are not depicted as loads of the vehicle power supply device, they are actually included in, for example, a low-voltage load 32D.

The DC/DC converter 80D is a bi-directional DC/DC converter as in the third embodiment described above. A high-voltage load 30D is 42V load(s) as in the third embodiment, and includes a starter 31 that starts an engine 52. In addition, the high-voltage load 30D may further include a short-term high power load that requires high power for a short period of time, such as a blower motor, a defogger, a brake actuator, a power steering unit (assist motor), and so on. The low-voltage load 32D is 14V load(s) (load(s) other than the high-voltage load 30D), and includes a low-power load. The low-voltage load 32D may include, e.g., various kinds of lamps, meters or ECUs. However, unlike the low-voltage load 32A in the first embodiment, the low-voltage load 32D may include a low-power load capable of operating when the engine is stopped, such as an anti-theft security system.

The engine ECU 52, which controls the engine 56 and the alternator 34, is connected to the control device SOD via an appropriate bus such as CAN. The control device 50D controls the operation of the vehicle power supply system 10D in cooperation with the engine ECU 52. The control device SOD is informed of the operating status of the engine 52 or the generation status of the alternator 34 via communications with the engine ECU 52. In the same manner, the engine ECU 52 may also be informed of the operating status of the DC/DC converter 80D via communications with the control device 50D. Further, the control device 50D receives an OFF signal (an ACC OFF signal) of an accessory switch and an OFF signal (an IG OFF signal) of the ignition switch. The ACC OFF signal is generated when the driver stops the engine (for example, when the driver turns the ignition key from an IG ON position to an ACC position or an IG OFF position), and is then input to the control device 50D.

Hereinafter, principal operations of the vehicle power supply system 10D in accordance with the fourth embodiment, performed under the control of the control device 50D and the engine ECU 52, will be described. The principal operations other than the operations performed when the engine is stopped (e.g., the principal operations of the power supply system 10D for a vehicle when the engine is starting or the engine is running) may be the same as those of the above-described third embodiment.

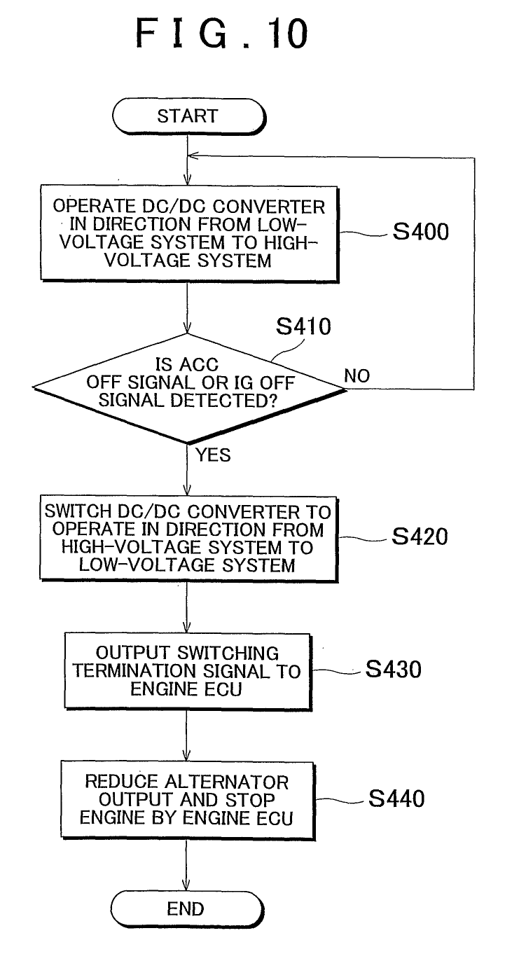

FIG. 10 is a flowchart illustrating an exemplary control method for the vehicle power supply system 10D, performed under the control of the control device 50D and the engine ECU 52 in relation to the engine stoppage.

As shown in FIG. 10, when the engine is running, the control device 50D monitors an occurrence of an ACC OFF signal and an IG OFF signal, and performs at step S400 the step-up operation of the DC/DC converter 80D until the ACC OFF signal or the IG OFF signal is detected (i.e., until YES at step S410). That is, the control device 50D operates the bi-directional DC/DC converter 80D in a direction from the low-voltage load 32D to the high-voltage load 30D.

If the ACC OFF signal or the IG OFF signal is detected (YES at step S410), the control device 50D operates the bi-directional DC/DC converter 80D in a direction from the high-voltage load 30D to the low-voltage load 32D (step S420). That is, if a pre-engine stop stage is detected (for example, the ACC OFF signal or the IG OFF signal is detected), the control device 50D switches the operating mode of the DC/DC converter 80D from the step-up operating mode to the step-down operating mode.

After the operating direction of the DC/DC converter 80D is switched, the control device 50D generates a switching termination signal to notify the engine ECU 52 of the switching (step S430). Further, the control device 50D may determine that the operation direction of the DC/DC converter 80D has been switched, when the voltage V1 on the low-voltage load side is increased to a prescribed value based on detection results of the voltage V1 on the low-voltage load side. The prescribed value may be, e.g., 14V.

Upon receiving the switching termination signal, the engine ECU 52 begins to reduce the output of the alternator 34, and simultaneously stops the engine 56 (at step S440).

As described above, in the fourth embodiment, the engine ECU 52 does not immediately stop the engine 56 even when, e.g., the vehicle driver turns the ignition key from the IG ON position to the ACC position or the IG OFF position, but rather stops the engine 56 after the operation of the DC/DC converter 80D has been fully switched from one direction to the other. Accordingly, the engine 56 may continue running even after the ACC OFF signal or the IG OFF signal is generated until the operating direction of the DC/DC converter 80D has been fully switched, thereby enabling the alternator 34 to generate sufficient power. It can be, therefore, ensured to prevent an instant stoppage of power supply to the low-voltage load 32D, which could otherwise occur when the engine 56 is stopped. In other words, the engine 56 is stopped only after the operation direction of the DC/DC converter 80D has been switched. Therefore, after the engine is stopped, the power from the battery 40 can be supplied to the low-voltage load 32D via the DC/DC converter 80D without an instantaneous interruption.

Further, in accordance with the fourth embodiment, as in the first embodiment, the dual power supply system, which is divided into a high-voltage system and a low-voltage system, can be implemented by using one battery, thus realizing reductions in cost and required accommodating space. Further, even if the DC/DC converter 80D fails to operate, the power for the low-voltage load 32D and the high-voltage load 30D necessary to pull over the vehicle can be supplied by the alternator 34 and the battery 40, respectively. A highly reliable power supply system may, thus, be realized.

Furthermore, in accordance with the fourth embodiment, as in the third embodiment, even if the alternator 34 fails while the engine is running, the power for the low-voltage load 32D and the high-voltage load 30D necessary to pull over the vehicle can be supplied from the battery 40 through the DC/DC converter 80D. Accordingly, a highly reliable power supply system can be realized.

Also, in the fourth embodiment, as in the third embodiment, since the battery 40 having a high rated voltage of 42V is disposed on the high-voltage load side, the high instantaneous electric power, which may be required to operate the high-voltage load 30D, can be drawn from the battery 40 as described above. Therefore, it is not necessary to allocate excessive performance specifications for the alternator 34 or the DC/DC converter 80D. Furthermore, the influence (e.g., the flickering of a lamp) on the operation of the low-voltage loads 32D, which is caused by the high power used when the high voltage loads 30D operate, can be prevented. Further, the present embodiment does not exclude a configuration in which the high-voltage load 30D without the starter 31 is disposed on the alternator side. Therefore, the high-voltage load 30D may be disposed on the alternator side, and the low-voltage load 32D may be disposed on the battery side.

Furthermore, if the present embodiment is configured such that various systems operate while the engine 56 is stopped (such as checking operations of an immobilizer system, a smart communications system and an ABS system), the control device 50D may be configured to continuously perform the step-down operation of the DC/DC converter 80D until the operations of those systems are completed. The control device 50D may intermittently operate the DC/DC converter 80D as described in the third embodiment after the operations of those systems are completed.

A fifth embodiment of the present invention differs from the first embodiment chiefly in that a DC/DC converter is operated in a bi-directional manner, and is characterized mainly by a control method of engine starting. Hereinafter, the elements identical to those of the first embodiment described above will be respectively assigned the same reference numerals, and descriptions thereof will be omitted.

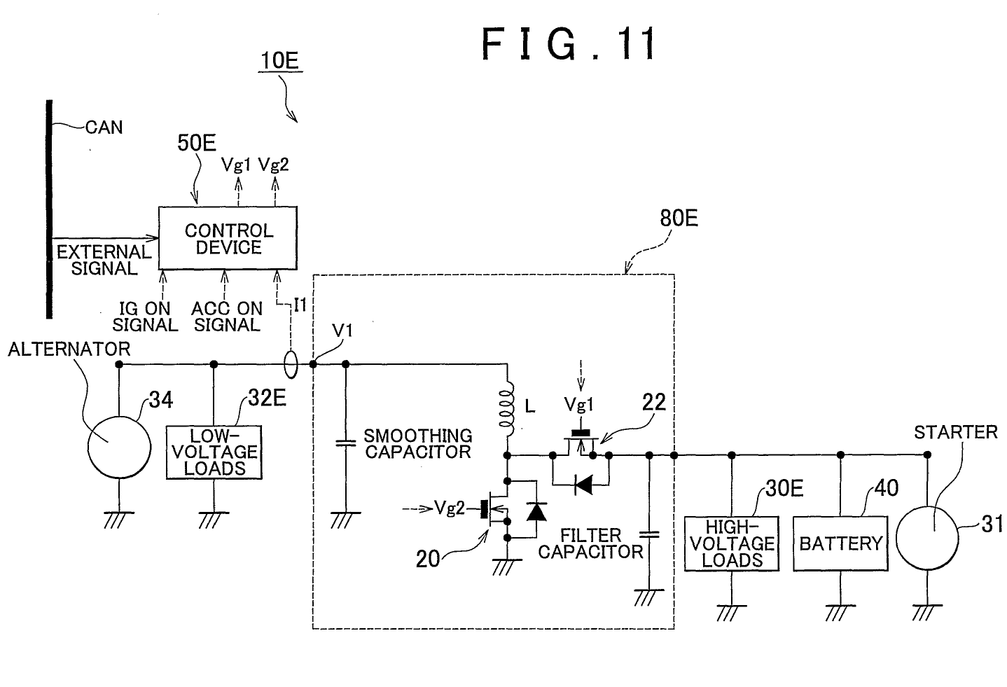

FIG. 11 is a system configuration diagram illustrating principal elements of a vehicle power supply system in accordance with the fifth embodiment of the present invention. In FIG. 11, a control system and a power supply system are illustrated as being divided. However, although a control device 50E is not depicted as loads of the vehicle power supply device, it is actually included in, for example, a low-voltage load 32E.

The DC/DC converter 80E is a bi-directional DC/DC converter as in the third embodiment described above. A high-voltage load 30E is 42V load(s) as in the third embodiment, and includes a starter 31 that starts an engine. In addition, the high-voltage load 30E may further include a short-term high power load that requires high power for a short period of time, such as a blower motor, a defogger, a brake actuator, and so on. The low-voltage load 32E is 14V load(s) (load(s) other than the high-voltage load 30E), and includes a low-power load. The low-voltage load 32E may include, e.g., various kinds of lamps, meters or ECUs. However, unlike the low-voltage load 32A in the first embodiment, the low-voltage load 32E may include a low-power load capable of operating when the engine is stopped, such as an anti-theft security system.

The control device 50E is connected to various vehicle equipments through an appropriate bus, such as CAN. As will be described later, the control device 50E detects a pre-engine start stage based on information (an external signal) gathered from the various vehicle equipments. The control device 50E monitors an external current I1 flowing from a low-voltage load by using, for example, a current sensor or a shunt resistor. Further, the control device 50E receives an ON signal (an ACC ON signal) of the accessory switch and an ON signal (an IG ON signal) of the ignition switch. The ACC ON signal and the IG ON signal are generated when the driver starts the engine by turning, for example, an ignition key from an IG OFF position to an ACC position or an IG ON position. The signals are then input to the control device 50E.

Hereinafter, principal operations of the vehicle power supply system 10E in accordance with the present fifth embodiment, performed under the control of the control device 50E and the engine ECU 52, will be described. Principal operations except those performed when the engine is started (e.g., principal operations of the vehicle power supply system 10E while the engine is stopped or the engine is running) may be the same as those discussed in the third and the fourth embodiment.

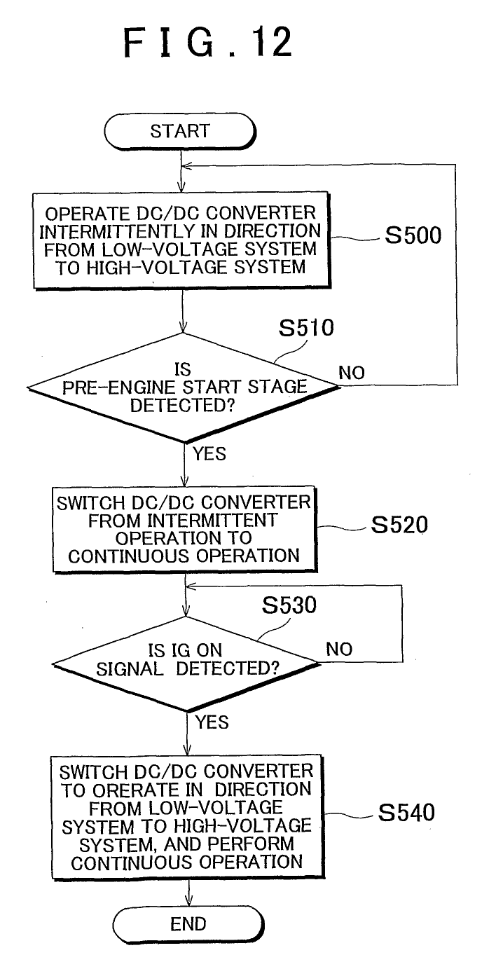

FIG. 12 is a flowchart illustrating an exemplary control method for the vehicle power supply system. The method is executed by the control device 10E while the engine of the vehicle is being started.

As shown in FIG. 12, while the engine is not in operation, the control device 50E performs an intermittent step-down operation of the DC/DC converter 80E (step S500) until the pre-engine start stage is detected (i.e., until YES at step S510). That is, the control device 50E operates the bi-directional DC/DC converter 80E intermittently in a direction from the high-voltage load 30E to the low-voltage load 32E. The intermittent operation of the DC/DC converter 80E may be performed in a manner similar to the corresponding operation described in the third embodiment.

At step S510, the control device 50E determines whether the engine at the present time is in the pre-engine start stage, based on at least one of the external signal and the external current I1. The pre-engine start stage may include: step 1 at which, a signal (electromagnetic wave) that indicates the driving intention of the driver to the vehicle is transmitted from a remote location, and the vehicle receives the signal; step 2 at which the user approaches a driver seat of the vehicle; step 3 at which the user unlocks the door; step 4 at which the user opens the driver-side door; step 5 at which the user sits down in the driver seat; step 6 at which the user inserts the ignition key; or step 7 at which the driver turns on the accessory switch.

For example, step 2 can be detected when a response signal, including a legitimate ID output from a portable key held by the driver, is detected by the receiver of the vehicle via a smart communications system. Step 3 can be detected by, e.g., one of the followings: an operating signal of a door lock actuator; an output signal of a touch sensor that detects whether the driver has touched an outside handle according to the smart communications system; a command signal of releasing a door lock transmitted from a portable key held by the driver according to a key entry system. Further, step 4 can be detected by, e.g., an output signal of the door switch. Furthermore, step 5 can be detected by, e.g., an output signal of a seat sensor (a pressure sensor) embedded within the seat. In addition to steps 1 to 7, the pre-engine start stage may further include the step at which, e.g., a body ECU (not shown) for integrally controlling electronic devices in vehicle body such as a door lock has been just turned on; or the step at which an in-car communications system (a CAN, etc.) has been just turned on.

However, it is preferred that the pre-engine start stage be detected before the requested electric power for the low-voltage load 32E is increased above a prescribed upper limit value. The prescribed “upper limit value” refers to a highest possible value of electric power that can be supplied through the intermittent operation of the DC/DC converter 80E. Whether or not the requested electric power for the low-voltage load 32E is greater than the upper limit value can be determined by monitoring an increase in the external current I1 or an occurrence of the external signal. Further, instead of or in addition to the external current I1, a voltage inside or outside the DC/DC converter 80E or a current flowing within the DC/DC converter 80E may be monitored. A current of the low-voltage load 32E (a low-voltage load current I2 that will be described later) and the like may be monitored. Furthermore, if a step among the steps 1 to 7 is previously known to be equivalent to the step at which the requested electric power for the low-voltage load 32E exceeds the prescribed upper limit value, the step before the corresponding step may be determined to be the pre-engine start stage. If the pre-engine start stage is detected (YES at step S510), the control device 50E operates the bi-directional DC/DC converter 80E continuously in a direction from the high-voltage load 30E to the low-voltage load 32E (step S520). That is, if the pre-engine start stage is detected, the control device 50E switches the operating mode of the DC/DC converter 80E from the intermittent operating mode to a continuous operating mode. In the continuous operating mode, the control device 50E operates the DC/DC converter 80E such that the output voltage V1 on the low-voltage load side can be maintained at a target value. Accordingly, power can be supplied from the battery 40 to the low-voltage load 32E via the DC/DC converter 80E without excess or deficiency. Thus, in the present embodiment, the required power for the low-voltage load 32E, which increases after the pre-engine start stage, can be supplied via the continuous operation by the DC/DC converter 80E.

If the IG ON signal is detected (YES at step S530), the control device 50E operates the bi-directional DC/DC converter 80E in a direction from the low-voltage load 32E to the high-voltage load 30E (step 540), because power is expected to be generated by the alternator 34. In other words, if the IG ON signal is detected, the control device 50E switches the operating mode of the DC/DC converter 80E from the step-down operating mode to the step-up operating mode. In the step-up operating mode, as described above, all the operations of the low-voltage load 32E are normally powered by the alternator 34. Further, in the step-up operating mode, the power generated by the alternator 34 is supplied to the side of the battery 40 via the DC/DC converter 80E whenever necessary, and thus is used to charge the battery 40 or to operate the high-voltage load 30E.

As described above, in accordance with the present embodiment, when the pre-engine start stage is detected, the operating mode of the DC/DC converter 80E is switched from the intermittent operating mode to the continuous operating mode. Therefore, the power required before the engine start-up can be supplied to the low-voltage load 32E sufficiently and efficiently.

Further, in accordance with the present fifth embodiment, as in the first embodiment, the dual power supply system, which is divided into a high-voltage system and a low-voltage system, can be implemented by using one battery, thus realizing reductions in cost and required accommodating space. Further, even when the DC/DC converter 80E fails to operate, power for the low-voltage load 32E and the high-voltage load 30E necessary to pull over the vehicle can be supplied from the alternator 34 and the battery 40, respectively. Accordingly, a highly reliable power supply system is realized.

In accordance with the fifth embodiment, as in the third embodiment described above, even if the alternator 34 fails to operate, the power for the low-voltage load 32E and the high-voltage load 30E necessary to pull over the vehicle can be supplied from the battery 40 through the DC/DC converter 80E. Accordingly, a highly reliable power supply system can be realized.

Further, in the fifth embodiment, as in the third embodiment described above, the battery 40 having a high rated voltage of 42V is disposed on the high-voltage load side. Therefore, a high instantaneous power, which may be necessary during the operation of the high-voltage load 30E, can be obtained by drawing the power from the battery 40 as described above. Therefore, it is not necessary to allocate excessive performance specifications to the alternator 34 and the DC/DC converter 80E. Further, the influence on the operation of the low-voltage load 30E (e.g., flickering of a lamp), which is caused by the high power used when the high-voltage load 30E is operating, can be prevented. Further, the present embodiment does not exclude a configuration in which high-voltage load 30E without the starter 31 is disposed on the alternator side. The high-voltage load 30E may be disposed on the alternator side and the low-voltage load 32E may be disposed on the battery side.

Further, in accordance with the present embodiment, because the amount of power generated by the alternator 34 may not be sufficient immediately after the engine is started, the DC/DC converter 80E may be configured such that the operating mode thereof is not switched immediately from the step-down operating mode to the step-up operating mode when the IG ON signal is detected, but the continuous operation or the intermittent operation may be performed for a while in the step-down operating mode. Likewise, if, for example, high electric power is not required before the engine start-up, the operating mode of the DC/DC converter 80E may be flipped from the intermittent operating mode to the continuous operating mode when detecting the IG ON signal, and the operating mode of the DC/DC converter 80E may be flipped from the step-down operating mode to the step-up operating mode when the amount of power generated by the alternator 34 becomes sufficient.

Furthermore, in the present embodiment, the continuous operating mode may not necessarily require that the DC/DC converter 80E operate in a completely continuous manner, but may be a mode in which the operation stoppage time of the intermittent operation of the DC/DC converter 80E is reduced.

A sixth embodiment of the present invention differs from the first embodiment chiefly in that a DC/DC converter is operated in a bi-directional manner, and is mainly characterized by a control method of charging the battery 40. Hereinafter, the elements identical to those of the first embodiment will be respectively assigned the same reference numerals, and descriptions thereof will be omitted.

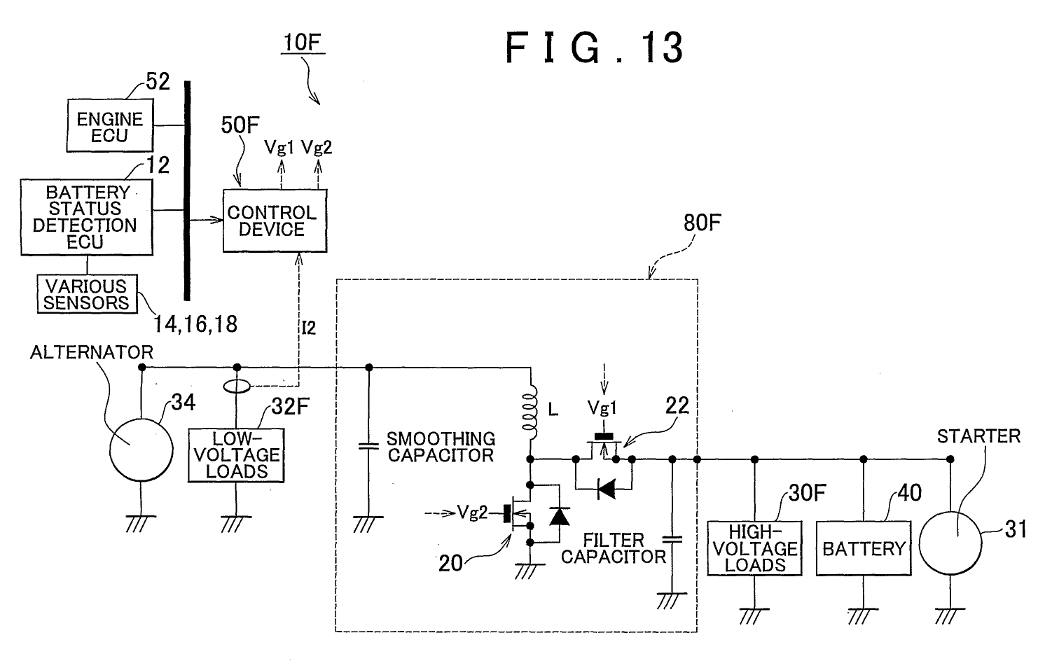

FIG. 13 is a system configuration diagram illustrating principal elements of a vehicle power supply system in accordance with the sixth embodiment of the present invention. In FIG. 13, a control system and a power supply system are illustrated as being divided. However, although a control device 50F, a battery status detection ECU 12 and various sensors 14, 16 and 18 are not depicted as loads of the vehicle power supply device, they are actually included in, for example, a low-voltage load 32F.

The DC/DC converter 80F is a bi-directional DC/DC converter as in the third embodiment described above. A high-voltage load 30F is 42V load(s) as in the third embodiment, and includes a starter 31 that starts the engine. In addition, the high-voltage load 30F may further include a short-term high power load that requires a high power for a short period of time such as a blower motor, a defogger and a brake actuator. The low-voltage load 32F is 14V load(s) (load(s) other than the high-voltage load 30F), and includes a low-power load. The low-voltage load 32F may include, e.g., various kinds of lamps, meters or ECUs. However, unlike the low-voltage load 32A in the first embodiment, the low-voltage load 32F may include a low-power load capable of operating while the engine is stopped, such as an anti-theft security system.

The control device 50F is connected to an engine ECU 52, which controls an alternator 34, and the battery status detection ECU 12 through an appropriate bus, such as CAN. The control device 50F controls the vehicle power supply system 10F in cooperation with the engine ECU 52. The control device 50F is informed of the generation status of the alternator 34 (for example, the target amount of power to be generated) via communications with the engine ECU 52. The control device 50F monitors a low-voltage load current I2 flowing from the low-voltage load by using, for example, a current sensor and/or a shunt resistor.

The battery status detection ECU 12 receives information of a battery current, a battery voltage, and a battery temperature. Here, the battery current is detected by the current sensor 14. The current sensor 14 is installed at, e.g., a positive terminal of a battery 40, and detects an amount of charging and discharging current of the battery 40 every sampling period, thereby supplying such signals to the battery status detection ECU 12. Further, the current sensor 14 converts the amount of variation in magnetic flux density, generated in a core unit by the charging and discharging current, into a voltage, and may output the voltage to the battery status detection ECU 12, by using, for example, a Hall integrated circuit (IC). The battery voltage is detected by the voltage sensor 16. The voltage sensor 16 is installed at the positive terminal of the battery 40, and detects the terminal voltage of the battery 40 every sampling period, thereby supplying such signals to the battery status detection ECU 12. Further, the battery temperature is detected by the battery temperature sensor 18, which includes a sensor unit configured by a thermistor. The battery temperature sensor 18 is installed, e.g., on a side of the insulator of the battery 40, and detects the liquid temperature (battery temperature) of the battery 40 every sampling period, thereby supplying such signals to the battery status detection ECU 12.

The battery status detection ECU 12 detects the state of charge (SOC) of the battery 40 based on the battery current, the battery voltage and the battery temperature, each of which is input every sampling period as described above. The method of detecting the SOC of the battery 40 is highly various, and may be any type of method as long as it works.

Hereinafter, principal operations of the vehicle power supply system 10F in accordance with the sixth embodiment, performed under the control of the control device 50F and the engine ECU 52, will be described. The principal operations other than the operations when the battery is being charged (e.g., the operations of the vehicle power supply system 10F performed when the engine is not running, is stopped, and is started) may be the same as those discussed in the third to fifth embodiments.

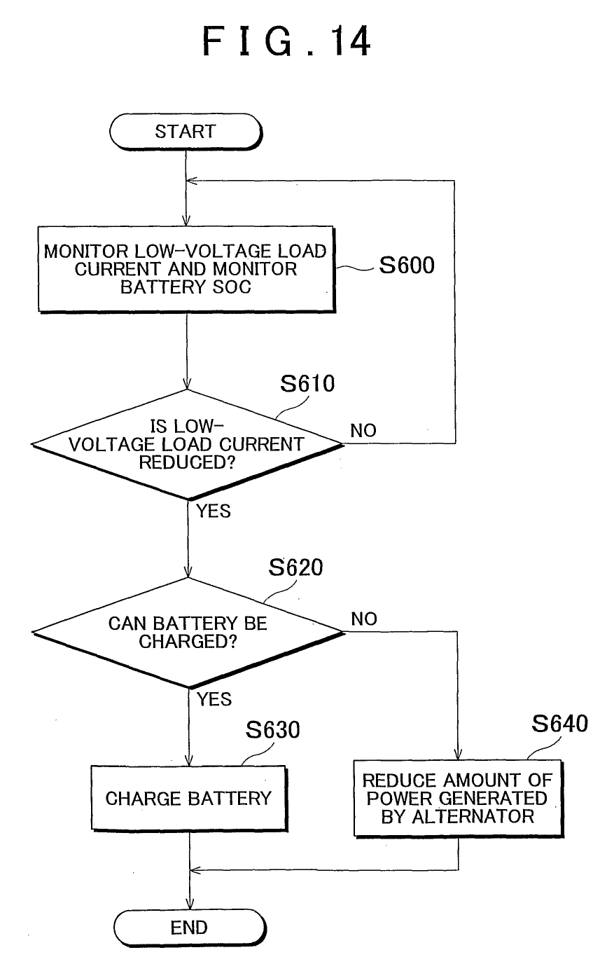

FIG. 14 is a flowchart illustrating an exemplary control method for the vehicle power supply system 10F. The method is executed by the control device 50F with respect to battery charging. The process shown in FIG. 14 is performed when the engine is running and the DC/DC converter 80F is operating in the step-up operating mode in a normal condition.

As shown in FIG. 14, the control device 50F monitors the detection results of the SOC of the battery 40 at step S600, which are provided by the battery status detection ECU 12 whenever necessary, until the low-voltage load current I2 on the low-voltage load side is reduced (i.e., until YES at step S610).

If a reduction in a low-voltage load current I2 is detected (YES at step S610) when, e.g., the operation of the low-voltage load 32F is terminated, the control device 50F determines at step S620 whether the battery 40 will be allowed to be charged in order to charge the battery 40 with the amount of reduction in the low-voltage load current. This determination is based on a current SOC of the battery 40. For example, if the current SOC of the battery 40 is 100% or sufficiently close to 100%, the control device 50F may determine that the battery 40 is not allowed to be charged. Alternatively, to secure a surplus amount to be charged in the battery 40 while the vehicle decelerates, the control device 50F may determine that the battery 40 is allowed to be charged only when the current SOC of the battery 40 is, e.g., 85% or less. In this case, the power (regenerative energy) generated by the alternator 34 while the vehicle decelerates can definitely be used for charging the battery 40. Thus, the gasoline mileage can be improved. Further, even if the electric power necessary for the low-voltage load is equal to the electric power generated by the alternator, when increase in a high-voltage load current or decrease in the SOC of the (high-voltage) battery is detected, the electric power may be increased, stepped up by the DC/DC converter and supplied to the battery to be charged or to the high-voltage load. Here, the high-voltage load current may be detected directly, or may be calculated from the stepped-up output current of the DC/DC converter (or estimated output current from the input current) and the battery current.

If it is determined at step S620 that the battery 40 is allowed to be charged, the control device 50F sets no restriction on the charging of battery 40. That is, the battery 40 is charged.

Meanwhile, if it is determined at step S620 that the battery 40 is not allowed to be charged, the control device 50F determines that the amount of power generated by the alternator 34 is higher than necessary, and sends a command to the engine ECU 52 to reduce the power generation by the alternator 34. Upon receiving the command, the engine ECU 52 either stops generating power by the alternator 34 or reduces the target amount of power generation.

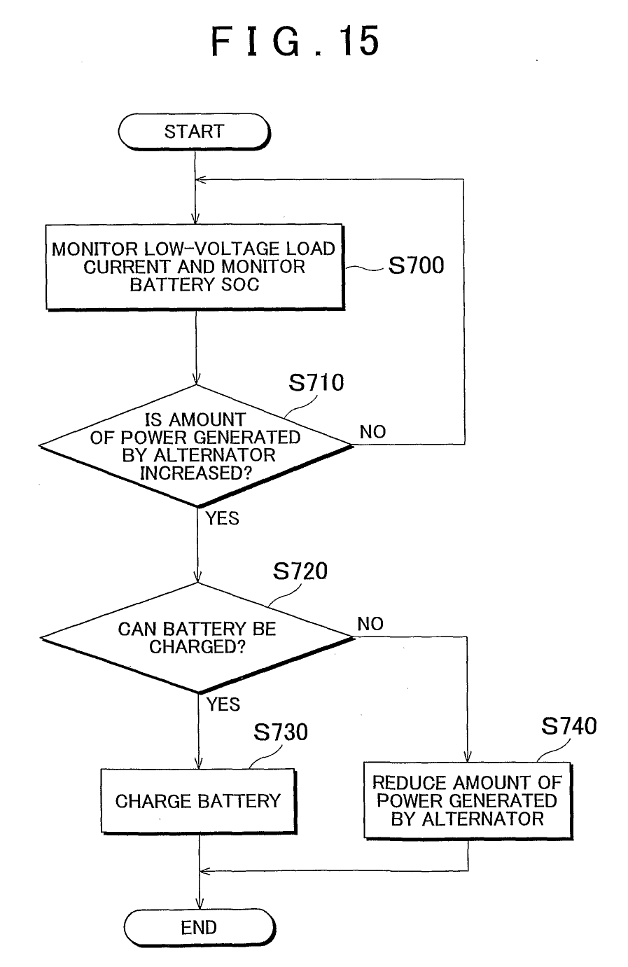

FIG. 15 is a flowchart illustrating another exemplary control method for the vehicle power supply system 10F. The method is executed by the control device 50F with respect to the battery charging. Herein, the process shown in FIG. 15 is performed in the normal state in which the engine is running and the DC/DC converter 80F is operated in the step-up operating mode.

As shown in FIG. 15, the control device 50F monitors the detection results for the SOC of the battery 40 (step S700), until the amount of power generated by the alternator 34 increases (i.e., until YES at step S710). The detection results are provided by the battery status detection ECU 12 whenever necessary.

If an increase in the amount of power generated by the alternator 34 is detected (YES at step S710) when, e.g., a vehicle is accelerated, the control device 50F determines at step S720 whether the battery 40 will be allowed to be charged in order to charge the battery 40 with the increased amount. This determination may be performed in a manner same as described above.

If it is determined at step S720 that the battery 40 is allowed to be charged, the control device 50F sets no restriction on the charging of the battery 40. That is, the battery 40 is charged.

Meanwhile, if it is determined at step S720 that the battery 40 is not allowed to be charged, the control device 50F determines that the amount of power generated by the alternator 34 is higher than necessary, and sends a command to the engine ECU 52 to reduce the power generation by the alternator 34. Upon receiving the command, the engine ECU 52 either stops generating power by the alternator 34, or reduces the target amount of power generation.

As described above, in accordance with the present embodiment, even if a chargeable battery is not provided on the alternator side, the power generation control for the alternator 34 can be optimized while charging the battery 40 with the power from the alternator 34.

Meanwhile, in the present embodiment, the function of the battery status detection ECU 12 may be embedded in the control device 50F. Similarly, the function of the engine ECU 52 may be embedded in the control device 50F.

So far, the embodiments of the present invention have been described in detail. However, the present invention is not limited thereto, and the above embodiments can be modified and the elements thereof can be changed in various ways within the scope of the present invention.

For example, although the low-voltage and the high-voltage system have been described in the above embodiments as operating respectively at 14V and 42V, the operating voltages can be set as desired as long as the operating voltage of the high-voltage system is noticeably different from that of the low-voltage system.

Furthermore, although, in the above embodiments, it is assumed that the vehicle is either a vehicle powered only by an engine or a hybrid vehicle powered by both an engine and an electric motor, the present invention can also be applied in an electric vehicle powered by an electric motor. In this case, the electric motor, instead of the starter 31, is disposed on the battery side as one of the high-voltage loads 30A to 30F. Further, in this case, the alternator that generates the electric power through the rotation of the output shaft of the electric motor may be disposed on the low-voltage load side as the alternator 34.

Further, although the DC/DC converter 80F is described in the sixth embodiment as a bi-directional DC/DC converter, the battery charging control shown in FIGS. 14 and 15 may be performed in the first and the second embodiments, which incorporate having the DC/DC converters 80A and 80B that are not bi-directional.

Furthermore, in the modification (see FIG. 4) of the second embodiment, the small-sized DC/DC converter included in the low-voltage load 32B or the common DC/DC converter 72 may undergo the step-down operation intermittently when the engine is stopped in a manner same as the DC/DC converter 80C of the third embodiment. Likewise, in the modification (see FIG. 4) of the second embodiment, the small-sized DC/DC converter included in the low-voltage load 32B or the common DC/DC converter 72 may be switched from the intermittent operation to the continuous operation when detecting the pre-engine start stage preceding the engine start-up in a manner same as the DC/DC converter 80D of the fourth embodiment.

Further, although the control methods are described in the third to the fifth embodiments to be performed when the vehicle driver stops or starts the engine, the control methods may also be performed when the engine is stopped or restarted according to an idle stop of the vehicle. Herein, the idle stop control is usually started when specific idle stop starting conditions are satisfied (when, e.g., a brake pedal is pressed at an intensity equal to or higher than a threshold value while the vehicle is stopped), and is finished when specific idle stop ending conditions are satisfied (when, e.g., the driver releases the brake pedal). Therefore, if the idle stop ending conditions are satisfied, the control device 50 completes the switching of the operation direction of the DC/DC converter 80 from the step-up direction to the step-down direction according to the control method of the fourth embodiment, and then stops the engine. During the idle stop, the control device 50 controls the DC/DC converter 80 to perform intermittently the step-down operation according to the control method of the third embodiment. During the idle stop, when it is a stage at which the idle stop ending condition is satisfied or a stage preceding thereto, the control device 50 switches the operating mode of the DC/DC converter 80E from the intermittent operating mode to the continuous operating mode according to the control method of the fifth embodiment.

Furthermore, although the alternator 34 has been described in the above embodiments to be controlled by the engine ECU 52, the alternator 34 may be controlled by other ECUs. Further, a power management ECU may be provided to be dedicated to control the alternator 34.

While the invention has been shown and described with respect to the embodiments, it will be understood by those skilled in the art that various changes and modifications may be made without departing from the scope of the invention as defined in the following claims.

1. A dual power supply system for a vehicle comprising:
a generator that generates an electric power by using a rotation output of an engine;
a DC/DC converter connected to the generator; and
a battery, connected to the generator via the DC/DC converter, that supplies an electric power; wherein
the DC/DC converter is a step-down or step-up converter that operates only in a direction from a generator side to a battery side,
a load disposed on the generator side and connected to the battery via the DC/DC converter is also connected to the battery not via the DC/DC converter, and
while an engine is stopped, the load disposed on the generator side is supplied with the electric power of the battery.

2. The dual power supply system of claim 1, wherein an electric power necessary for a normal operation of a load is supplied by the battery and generated by the generator.

3. The dual power supply system of claim 1, wherein loads required when pulling the vehicle over are disposed divided on an input side and an output side of the DC/DC converter, and
wherein, when the DC/DC converter is not operating, the loads required when pulling the vehicle over are supplied with the electric power by the battery and the electric power generated by the generator.

4. The dual power supply system of claim 1, wherein the battery is connected to the load disposed on the generator side via an additional DC/DC converter, the additional DC/DC converter having a smaller capacity than the DC/DC converter and being used in supplying a standby current.

5. The dual power supply system of claim 1, wherein a low-voltage load is connected to the generator side of the DC/DC converter, and a high-voltage load is connected to the battery side of the DC/DC converter.

6. The dual power supply system of claim 4, wherein a low-voltage load is connected to the generator side of the DC/DC converter, and a high-voltage load is connected to the battery side of the DC/DC converter.

7. A power supply method for a vehicle, in which all electric powers consumed by the vehicle are supplied essentially by a battery and a generator connected to the battery via a DC/DC converter, wherein the DC/DC converter is a step-down or step-up converter that operates only in a direction from a generator side to a battery side, and wherein a load disposed on the generator side and connected to the battery via the DC/DC converter is also connected to the battery not via the DC/DC converter, the method comprising:
generating an electric power by the generator using a rotation output of an engine; and
supplying an electric power of the battery to the load disposed on the generator side not via the DC/DC converter, while the engine is stopped.

8. The power supply method of claim 7, wherein, while the engine is stopped, the load disposed on the generator side is supplied with the electric power of the battery via an additional converter.
